(19) United States
(12) Patent Application Publication
(10) Pub. No.: US 2014/0058912 A1
(43) Pub. Date: Feb. 27, 2014

(54) Determination of Account Status

(71) Applicant: Hitesh Bajaj, Johns Creek, GA (US)

(72) Inventor: Hitesh Bajaj, Johns Creek, GA (US)

(73) Assignee: Bank of America Corporation, Charlotte, NC (US)

(21) Appl. No.: 13/592,563

(22) Filed: Aug. 23, 2012

(51) Int. Cl. G06Q 40/00

(52) U.S. Cl. 705/35

(57) ABSTRACT

According to an embodiment, status of an account is determined. A plurality of graphic areas is displayed. Each of the graphic areas is associated with a client application. In a first graphic area of the plurality of graphic areas, a first image is displayed that indicates a first status associated with the account. A communication associated with the account is received. In response to receiving the communication, the first image in the first graphic area is replaced with a second image indicative of a second status associated with the account.

### TECHNICAL FIELD OF THE INVENTION

This invention relates, in general, to account status and, more particularly, to determination and indication of account status.

### BACKGROUND OF THE INVENTION

A user may have one or more accounts managed by an enterprise. These accounts may be subject to transactions associated with the account that are initiated by the user or another party. Given the technology available, these transactions can be performed at any given time. In some instances, these transactions may have adverse consequences for the account.

### SUMMARY OF THE INVENTION

In accordance with the present invention, disadvantages and problems associated with determination of account status may be reduced or eliminated.

According to one embodiment of the present invention, status of an account is determined. A metric associated with an account is retrieved. Rules for determining a status of the account are accessed. A processer determines the status of the account based on the metric associated with the account and the rules for determining the status of the account. The status of the account is communicated to a device for display in a first graphic area of a plurality of graphic areas on a device. Each of the graphic areas is associated with a client application.

According to another embodiment of the present invention, status of an account is determined. A plurality of graphic areas is displayed. Each of the graphic areas is associated with a client application. In a first graphic area of the plurality of graphic areas, a first image is displayed that indicates a first status associated with an account. A communication associated with the account is received. In response to receiving the communication, the first image in the first graphic area is replaced with a second image indicative of a second status associated with the account.

Certain embodiments of the invention may provide one or more technical advantages. A technical advantage of one embodiment allows for determination of status of an account and reporting of that status to a device associated with the account. The status may be displayed on the device without opening on the device a client application associated with the account. A technical advantage of an embodiment allows for a user associated with the account to receive an update with the status in response to an action associated with the account that sends the account into a poor health status. As another example, a technical advantage of an embodiment allows for a background and/or theme of a client application to change in response to a change in the status of the account.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system operable to determine status of an account and report the status to a device associated with the account.

FIG. 2 illustrates an example flow chart for determining status of an account and reporting the status to device associated with the account.

FIG. 3 illustrates an example flow chart for determining status of an account and displaying the status on a device associated with the account.

### DETAILED DESCRIPTION OF THE INVENTION

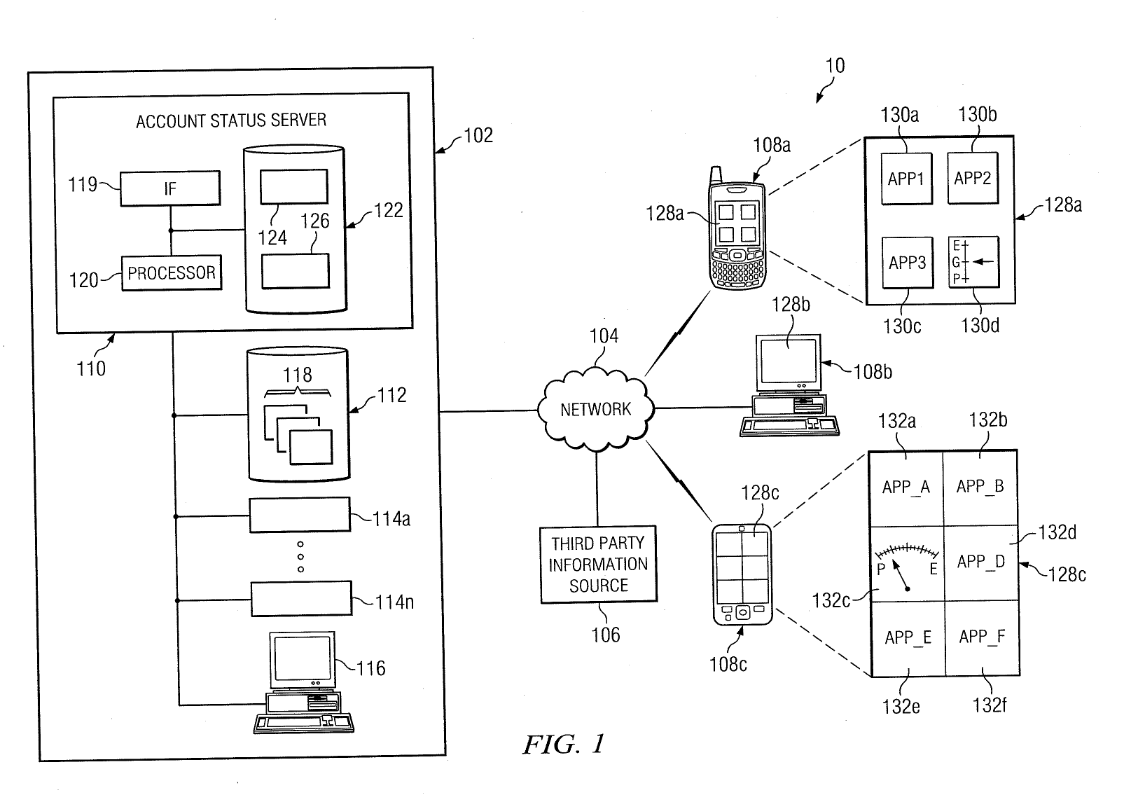

Embodiments of the present invention and its advantages are best understood by referring to FIGS. 1 through 3, like numerals being used for like and corresponding parts of the various drawings.

FIG. 1 illustrates a system 10 operable to determine status information of an account and report that information to an account user, as needed. System 10 includes an account management system 102 that performs actions on accounts based on information received through network 104 from third party information source 106 and from devices 108. These actions may affect the status of the account. For example, certain account actions may reduce a level of available funds in an account, which may correspond to a poor health status. In another example, an action associated with an account may increase a level of available funds. This may result in a good health status for the account. In particular embodiments, the status of an account is automatically communicated to a user of a device 108 over network 104, when the account status changes. Devices 108, in some embodiments, operate to display account status through various graphical images shown on a base screen of a device 108. The account status may be automatically displayed to an account user on a device 108 even when the user is not currently interacting with a client application directly associated with the account.

System 10 operates on any suitable account type that can be rated with a status, which may change based on actions associated with the account. As non-limiting examples, system 10 may operate on any form of banking accounts, brokerage accounts, investment accounts, credit card accounts, insurance accounts, utility service accounts, and/or phone service accounts. These accounts may be an aggregate of other accounts, such that status information gives an overall picture for the plural accounts. For example, a banking account may represent an aggregate of a checking account, a savings account, and/or a credit card account.

Account management system 102 includes any suitable combination of components that operate to manipulate, access, and/or report on an account. For example, account management system 102 may include the computing systems controlled by a financial institution, such as a bank, brokerage house, or investment firm. Account management system 102 allows, in certain embodiments, components such as devices 108 to access accounts that are under the control of account management system 102. Likewise, account management system 102 may provide status updates for accounts to account users through communications with devices 108. Account management system 102 may include various components operable to carry out actions in connection with user accounts. Certain embodiments of account management system 102 include an account status server 110, an account database 112, functional modules 114, and an administrative computer 116 communicatively coupled in any suitable manner.

Account database 112 stores, either permanently or temporarily, data, operational software, or other information for use by the components of account management system 102. Account database 112 includes any one or a combination of volatile or nonvolatile local or remote devices suitable for storing information. For example, account database 112 may include RAM, ROM, magnetic storage devices, optical storage devices, any other suitable information storage device, or a combination of these devices. While illustrated as including particular modules, account database 112 may include any suitable information for use in the operation of account management system 102.

In certain embodiments, account database 112 includes account profiles 118. Account profiles 118 may include any suitable information associated with accounts under the control of account management system 102. For example, account profiles 118 may include identifying information such as an account user's name, date of birth, address, phone number, and/or any other suitable identifying information. Account profiles 118 may also include account numbers, nicknames for accounts, account identifiers associated with an account, balance information of an account, limits of an account, disclaimers associated with an account, customer preferences, any other suitable data, or any suitable combination of the preceding. Account profiles 118 include, in certain embodiments, information associated with historical metrics of an account, such as historical balance information, dates/amounts of previous withdrawals/deposits, attempted/actual accesses by certain devices 108, attempted, and/or any other historical information. An account profile 118 may include information regarding all accounts maintained by the user at account management system 102 and/or each account profile 118 may maintain information only for a subset of the user's accounts. Additionally, account profiles 118 may store information associated with a user of an account managed by account management system 102. For example, user profiles 118 may store one or more credit scores associated with the user or may store information related to other accounts owned by a user but not directly managed by account management system 102. Account profiles 118 may also include information about which devices 108 should receive and/or that may request status updates for a particular account.

Account management system 102 may include one or more functional modules 114 that carry out any suitable actions associated with the accounts managed by account management system 102. For example, a functional module 114 that facilitates peer-to-peer transfers may transfer funds from one user's account to another user's account. As another example, another functional module 114 could perform interactive voice response (“IVR”) functions such as allowing a user to check balance information through telephone interaction. Functional modules 114 may authenticate users and provide balance information, for example, by accessing appropriate account profiles 118 in account database 112. Other functional modules 114 may permit payment of bills on-line, selection and/or addition of new payees, creation of new accounts, initiation of wire transfers, processing of payment transactions from a third-party merchant, and/or any other suitable function. The activity occurring through functional modules 114 may affect account information stored in an account profile 118, such as the amount of funds available in a user account. As will be described in more detail below, these changes to accounts may be monitored by account status server 110, which may report those changes as account status updates to users through appropriate devices 108.

Functional modules 114 may include a network server, any suitable remote server, a mainframe, a host computer, a workstation, a web server, a personal computer, a file, server, or any other suitable device operable to perform an action associated with an account. In some embodiments, functional modules 114 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of functional modules 114 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

Account status server 110 represents any suitable components that facilitate determination of a status of an account under the control of account management system 102. Account status server 110 couples to any suitable components of account management system 102 to determine and report status information. For example, account status server 110 may access current and historical information associated with an account from account database 112. In certain embodiments, account status server 110 receives information related to an account and/or a user of an account from third-party information source 106. Account status server 110 may determine a status of an account when requested by a user of a device 108, according to a predetermined time interval (e.g., equally-spaced time intervals and/or an arbitrary schedule), upon detection of an attempted action associated with an account, upon detection of a completed action associated with an account, or at any other suitable time. For example, account status server 110 may determine account status on a daily basis. Account status server may then report the status to a device 108 at any suitable time period, such as any suitable time after determination of the status of an account and/or when certain conditions have been reached, such as upon determination of a certain status (e.g., a poor health status).

Account status server 110 may include a network server, any suitable remote server, a mainframe, a host computer, a workstation, a web server, a personal computer, a file, server, or any other suitable device operable to determine and/or report status information of an account. In some embodiments, account status server 110 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of account status server 110 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In certain embodiments, account status server 110 includes a network interface 119, a processor 120, and a memory 122.

Network interface 119 represents any suitable device operable to receive information from network 104, perform suitable processing of the information, communicate to other devices, or any combination of the preceding. For example, network interface 119 may receive a request to determine status information for a particular account from device 108a. Network interface 119 represents any port or connection, real or virtual, including any suitable hardware and/or software, including protocol conversion and data processing capabilities, to communicate through a LAN, WAN, or other communication systems that allows account status server 110 to exchange information with the other components of account management system 102, network 104, third-party information source 106, devices 108, and/or any other suitable device.

Memory 122 stores, either permanently or temporarily, data, operational software, or other information for processor 120. Memory 122 includes any one or a combination of volatile or nonvolatile local or remote devices suitable for storing information. For example, memory 122 may include random access memory (RAM), read only memory (ROM), magnetic storage devices, optical storage devices, or any other suitable information storage device or a combination of these devices. While illustrated as including particular modules, memory 122 may include any suitable information for use in the operation of account status server 110.

In certain embodiments, memory 122 includes management software 124 and management data 126. Management software 124 represents any suitable set of instructions, logic, or code embodied in a non-transitory, computer readable medium and operable to facilitate the operation of account status server 110. For example, management software 124 may include application files sufficient when executed to determine status information of an account. Management software 124 may reference information stored in management data 126. Management data 126 includes any rules used by management software 124 in carrying out its functions. For example, management data 126 includes rules that determine the appropriate time for determining account status and reporting status information. As another example, management data 126 includes rules that specify the factors that determine appropriate status determination.

In certain embodiments, rules in management data 126 may indicate that account status depends on how closely account users are able to adhere to target budget allocation in the short-term or long-term. For example, account users may specify a target allocation for different categories of expenses, such as housing, food, entertainment, transportation, clothing, and/or any other suitable category. The allocation may be set as a percentage of all expenses and/or as a set amount of expenses for a particular category. The account user may specify that exceeding the allocation may send the account into a lower-rated health status in any suitable fashion, such as exceeding the allocation on any number of categories.

Rules in management data 126, in particular embodiments, may monitor prior expenses for an account in determining health status. The rules may indicate that the health status of an account should be rated lower if the amount of available funds in the account are less than the historical amount of expenses for a given time period, e.g., a month. Conversely, the health status of an account may be rated “good” if the amount of funds in the account exceeds the amount of historical expenses and “very good” if the amount of the funds in the account significantly exceeds the amount of historical expenses (e.g., by two times, three times, and/or any other suitable measure).

In some embodiments, rules in management data 126 may monitor the type and/or quantity of transactions. For example, if a user has a certain number of transfers within a time period, the rules may indicate that the account has a poor health status. As another example, the rules may indicate the number/type of transactions that an account has should be compared to historical number/type of transactions. If the number exceeds the historical number of transactions by a certain amount, the rules may indicate that the account should be rated at a lower health status. Additionally, if the type of transaction varies from the historical type of transactions, the rules may indicate that the account should be rated at a lower health status.

Additionally, rules in management data 126 may indicate that the status should be determined under the assumption that a pending transaction is actually completed. For example, a user of an account may have initiated an action, such as a bank transfer or scheduled a bill payment at a future time. The rules may determine the account status assuming those transactions are completed before the transactions are actually completed. In this way, account status server 110 may report status of an account prospectively before certain actions are completed. This may give a user an opportunity to cancel a transaction or take other actions to mitigate a prospective poor health status, such as transferring additional funds into the account.

In particular embodiments, rules in management data 126 take into account information from sources outside of account management system 102 to determine appropriate status. For example, status information for an account may depend on a credit rating of a user of the account. Account status server 110 may monitor credit scores of a user a reported by commercial credit bureaus, such as Equifax TransUnion, Experian, and/or any other suitable credit bureau. As one example, a mediocre credit score for a user combined with a pending bill deadline that a user is about to miss may indicate that the account should be in a lower health status.

As additional examples, rules in management data 126 may indicate that the value of assets should be monitored. For example, if the account relates to a loan for a house, the value of the house could be monitored by accessing information from third-party information source 106. If the value of house is below the value of the outstanding loan, this could be a factor in changing the account status to a poor state. For this example, the values of neighboring houses may factor into the rating for the account status. As another example, rules in management data 126 may specify that interest rates on credit card accounts and the balances themselves may be monitored. The rules may specify that a certain interest rate and/or credit card balance could trigger the account going into a poor state or a good state. As another example, for a brokerage account, an account owner's investment holdings may be monitored and compared with predefined thresholds. When the values reach a certain amount, a particular account state may be triggered.

The rules in management data 126 that specify the status of an account may be specified by the user of an account, pre-set in account status server 110, configured by an administrator of account management system 102 through administrative computer 116, automatically set by monitoring account activity of several users, and/or any suitable combination of the preceding. For example, account status server 110 may set the target budget allocation based on a function of the historical allocations of several accounts owned by several account users. Likewise, the type/quantity of transactions, amount of available funds, and/or any other suitable factor that indicates the status of an account may depend, in part, on those historical metrics for other accounts.

Rules in management data 126 may use any combination of the preceding factors in determining a cumulative health score for an account. This cumulative health score may be reported to a user at a device 108 through network 104. The cumulative health score may give a user an overall picture of their account's health.

Processor 120 communicatively couples to network interface 119 and memory 122. Processor 120 controls the operation and administration of account status server 110 by processing information received from network interface 119 and memory 122. Processor 120 includes any hardware and/or software that operates to control and process information. For example, processor 120 executes management software 124 to control the operation of account status server 110. Processor 120 may be a programmable logic device, a microcontroller, a microprocessor, any suitable processing device, or any suitable combination of the preceding.

Administrative computer 116 represents any suitable components that facilitate establishment and/or modification of the configuration of any of the components of account management system 102. An administrator may use administrative computer 116 to update the rules in management data 126 that determine the particular status rating of an account. For example, an administrator may analyze the history of several accounts to determine average indicators for poor and/or good overall status of accounts. The administrator may then update rules in management data 126 using administrative computer 116. As another example, administrative computer 116 may include software that monitors accounts and determines average ratings automatically in response to monitoring those metrics.

Administrative computer 116 may comprise a network server, any suitable remote server, a mainframe, a host computer, a workstation, a web server, a personal computer, a file, server, or any other suitable device operable to configure the components and rules used by account management system 102. In some embodiments, administrative computer 116 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of administrative computer 116 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

Network 104 represents any suitable network that facilitates communication between the components of system 10. Network 104 may include any interconnecting system capable of transmitting audio, video, signals, data, messages, or any combination of the preceding. Network 104 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

Third-party information source 106 may refer to a financial institution, such as a bank, brokerage house, investment firm, or credit bureau that that provides information used by one or more components of account management system 102. For example, as a credit bureau, third-party information source 106 may communicate a credit score associated with a user to any suitable component of account management system 102, such as account status server 110 or any suitable functional module 114. The credit score may be stored in account profile 118 and used by account status server 110 in determination of a status of an account. Even though third-party information source 106 is referred to as a financial institution, third-party information source 106 represents any suitable type of entity in any suitable industry that has information that may relate to rules applied by account status server 110.

Devices 108 may comprise any type of mobile or stationary computing device operable to communicate with account management system 102 regarding account status. Examples of devices 108 include a mobile phone, personal digital assistant, laptop, netbook, ultrabook, tablet, desktop computer, cable box, television, automobile, and/or any other suitable device. Certain embodiments of system 10 include a device 108a that is a mobile phone, a device 108b that is a desktop computer, and a device 108c that is a tablet.

Devices 108 include any necessary hardware and software suitable to carry out its functions. For example, devices 108 may include a processor similar to processor 120 for executing routines associated with receiving and requesting status information. A processor included in device 108 may comprise a programmable logic device, a microcontroller, a microprocessor, any suitable processing device, or any suitable combination of the preceding. Devices 108 may also include a memory similar to memory 122 for storing software and data related to those software programs. Similarly, data may be input from a user and stored on device 108 in such a memory. Where appropriate, devices 108 may include a network interface similar to network interface 119 to implement the communication protocols to allow device 108 to communicate with the other components of system 10.

Devices 108 may include any suitable software to carry out its functions. For example, devices 108 may run any suitable operating system such as WINDOWS, MAC-OS, UNIX, LINUX, iOS, Windows Mobile, Android, and/or any other suitable operating system. Devices 108 may also include any suitable native applications, such as a web browser application, a messaging application, and/or a natively-installed client application configured to work with one or more components of account management system 102 (i.e., an account manager application). A user of a device 108 may use an account manager application natively installed on device 108 to access and/or initiate actions associated with accounts under the control of account management system 102.

Devices 108 include graphical user interfaces (“GUIs”) 128 that display information and available functionality to users of devices 108. Various client applications may be accessible to the user from a base screen (e.g., a home screen or desktop) of GUI 128 that includes one or more regions or graphic areas. In particular embodiments, each graphic area is associated with a client application installed natively on device 108. A user may access the client applications using any suitable mechanism. For example, a user may touch an area sufficiently proximate to a graphic area to start up its corresponding client application in embodiments where GUI 128 is presented on a touch screen. In certain embodiments, a user may navigate to a particular graphic area of GUI 128 and initiate a particular client application by using an input device (e.g., using buttons of a keypad and/or by using dragging a mouse and pressing suitable buttons).

GUI 128a has graphic areas 130 that each correspond to a unique client application installed on device 108a. In certain embodiments, graphic areas 130 are icons. Graphic area 130d corresponds to an account manager application that gives a user of device 108a access to one or more components of account manager system 102. Graphic area 130d depicts an image that gives a user of device 108a an indication of the health status of an account under the control of account manager system 102. Graphic area 130d is able to show three levels of status for an account. “E” indicates that the account has an excellent health status. “G” indicates that the account has a good health status. “P” indicates that the account has a poor health status. The illustrated embodiment indicates that the account under the control of account management system 102 has a good health status. If the status of the account changes, this may be reported to device 108a by the account status server 110 of account management system 102. If the status changes to excellent, the arrow in graphic area 130d changes to point to the “E.” If the status changes to poor, the arrow in the graphic area 130 changes to point to the “P.” The user is notified of the changes of the status of the account without initiating the account manager application.

GUI 128c has graphic areas 132 that each correspond to a unique client application installed on device 108c. In certain embodiments, graphic areas 132 are tiles, such as those used in Windows live tile. Graphic area 132c corresponds to an account manager application that gives a user of device 108c access to one or more components of account manager system 102. Graphic area 132c depicts an image that shows the status of an account under the control of account manager system 102 on a status continuum from “poor” to “excellent.” As variations in the status of the account are determined and reported by account status server 110, the arrow in graphic area 132c changes accordingly. In certain embodiments, the tile may “flip” to another tile to indicate a change in status. Again, as with device 108a, the user of device 108c may see the current status and changes in that status without initiating the application that corresponds with graphic area 132c.

In certain embodiments, the user may initiate the account manager application on device 108a and/or device 108c to obtain more details regarding the changes in account status and/or to view a dashboard of different indicators that show the status of a subset of parameters that the account owner may have set for their account. The dashboard may have different types of visual indications of status for their different metrics that may have been set up during the enrollment process. For example, there may be meters for available balance, current monthly expenses for various categories of expenses, number/type of transactions, and/or any other suitable transaction. The meters may show actual metrics versus the targets (as specified by the user and/or the account manager system). A needle falling below a target threshold could trigger a change in status. If a user is actively interacting with the account manager application, the change in status may appear as a change in the general theme and/or background of the account manger application. For example, the background color could change from green to red. As another example, the font and/or window sizes may change in response to a change in status.

In an exemplary embodiment of operation of system 10, an account owner enrolls in status checking for an account under the control of account management system 102. As part of the enrollment process, the account owner specifies a target budget allocation in the form of expense limits for the month, which are stored in management data 126. Account status server 110 also analyzes past transaction history and type for this account to determine rules for determining what conditions equate with excellent, good, and poor account status, respectively. The account owner installs a client manager application on each of its mobile device 108a and tablet device 108c. Identifying information about devices 108a and 108c are stored in management data 126. Initially, both device 108a and device 108c show the account has a good health status.

At some point after enrollment, a user with privileges to the account initiates a transaction involving the account with a merchant, reducing the funds in the account by a large amount. Account management system 102 detects that a transaction has been initiated for an account under its control. Account status server 110 accesses account profiles 118 and management data 126 to determine the amount of available funds in the account and the appropriate conditions for each of the available account statuses. Account status server 110 determines that the type of merchant transfer is out of the ordinary for this account and exceeds the budget allocation set for this account. Account status server 110 accesses information about the devices that have been set up to receive status alerts for this account from management data 126. Account status server 110 then communicates this status change to devices 108a and 108c. Account status server 110 may also send the account owner a push notification, which includes information regarding the change in status. This may come in the form of an SMS text message, an e-mail, or any other suitable messaging technique.

When device 108a receives the update regarding status of the account, the user of device 108a is not using the account manager application natively installed on device 108a. On the base screen, the arrow in graphic area 130d moves from “G” to “P,” indicating that the account moved from good to poor status. The user then starts the account manager application associated with graphic area 130d to determine why the account was switched to poor health status. The user sees the transaction involving the merchant and takes steps to move the account back into good health status.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, the status of an account as shown through graphic areas 130d and 132c may be shown in any suitable manner. For example, a change in color in all or a portion of the graphic may be used to indicate a change in account status. Graphic areas may also include text to indicate the current account status. Other possible ways to indicate status may include the specific shape or the specific border shown in graphic area 130d. Additionally, graphic area 132c may be configured to show unique “tiles” for a specific status. These may be configured to display for a certain amount of time and then return back to a normal state. In some embodiments, the general theme and/or background of the account manager application installed on devices 108 may change while the user is actively interacting with that application to indicate change in account status. Furthermore, the components of system 10 may be integrated or separated. For example, some embodiments of account status server 110 may include account database 112.

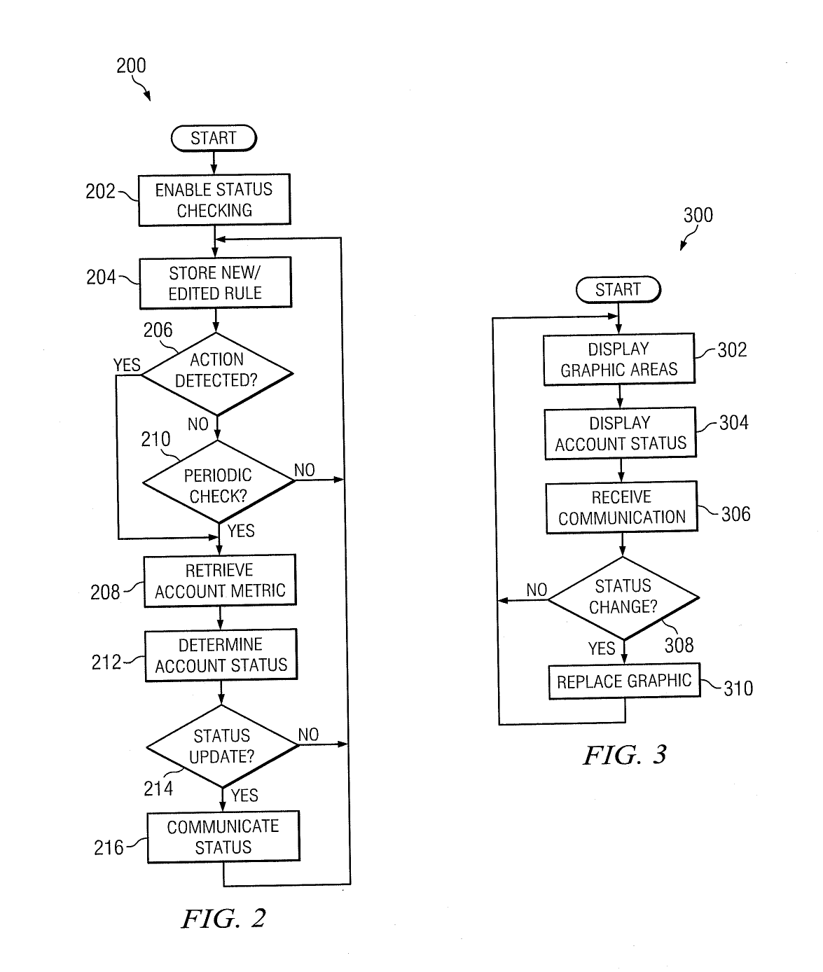

FIG. 2 illustrates an example method 200 for determining status of an account. The method begins at step 202, where status checking is enabled for an account. An account owner may enroll in status checking during this step. At step 204, rules that indicate the association between the account metrics and a particular status are added and/or updated. At step 206, the account management system determines whether an action associated with the account has occurred. If an action has occurred, the method continues with step 208. If an action has not occurred, the method determines whether the account management system has been configured to check status according to a schedule or periodically at step 210. If the system has not been configured as such, the method returns to step 204. If the system has been configured with periodic checking, the system waits for the specified amount of time and then continues to step 208. At step 208, metrics associated with the account are retrieved. These metrics may include the account balance, amount of the previous transactions, type of previous transactions, and/or any other suitable account metric. At step 212, the method determines the account status according to the rules specified during step 204. At step 214, the method determines whether the status has changed from its previous status. If the status has not changed, the method returns to step 204. If the status has changed, the method continues with step 216 where the new status is communicated to a device. The device may have graphic areas upon which status may be indicated.

Modifications, additions, or omissions may be made to method 200 disclosed herein without departing from the scope of the invention. The methods may include more, fewer, or other steps. For example, the method may exclude step 202, such that the accounts are always subject to status checking without enrollment by the account owner. As another example, the method may exclude one of steps 206 and 210. If the method excludes step 210, the method may perform checks only when actions associated with the account are detected. If the method excludes step 206, the method may perform checks only according to some predetermined schedule. Additionally, steps may be performed in parallel or in any suitable order. For example, steps 206 and 210 may be performed in parallel, such that status checking may occur in either the case that an action is detected or when a time is reached according to a predetermined schedule.

FIG. 3 illustrates an example method 300 for determining status of an account. The method begins at step 302 where one or more graphic areas are displayed on a graphical user interface of a device. Each of the graphic areas may correspond to a client application natively installed on the device. At step 304, a graphic area associated with the account graphically indicates the status of an account. This indication may be by shape, color, shading, text, flashing, any other suitable graphical indication, and/or any suitable combination of the preceding. At step 306, a communication is received that includes information associated with the status of the account. At step 308, the method determines whether the status of the account has changed from the previous status. If the status has changed, the graphic area associated with the account may be replaced with another graphic that indicates the status. The replacement of this graphic may occur even though the user of the device is not actively interacting with the natively-installed application associated with the account. If the status has not changed, the method may return to step 302.

Modifications, additions, or omissions may be made to method 300 disclosed herein without departing from the scope of the invention. The methods may include more, fewer, or other steps. For example, another step may be included in which the device runs the natively installed application associated with the account to allow the user to enroll in and configure status checking. While shown as the active screen, the theme/or background of the application may change if the status of the account changes. Additionally, method 300 may include another step where a push notification with information about the status is received. As another example, at step 306 if the status has changed, the communication may include information specifying why the status has changed and/or recommended actions to move the account into a different status. Additionally, steps may be performed in parallel or in any suitable order. For example, a communication may be received at step 306 before account status is displayed in step 304.

Certain embodiments of the invention may provide one or more technical advantages. A technical advantage of one embodiment allows for determination of status of an account and reporting of that status to a device associated with the account. The status may be displayed on the device without opening on the device a client application associated with the account. A technical advantage of an embodiment allows for a user associated with the account to receive an update with the status in response to an action associated with the account that sends the account into a poor health status. As another example, a technical advantage of an embodiment allows for a background and/or theme of a client application to change in response to a change in the status of the account.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. An account status server for determining a status of an account, comprising:
a memory comprising rules for determining a status of an account; and
a processor communicatively coupled to the memory and operable to:
retrieve a metric associated with the account;
access the rules for determining the status of the account;
determine the status of the account based on the metric associated with the account and the rules for determining the status of the account; and
communicate the status of the account to a device for display in a first graphic area of a plurality of graphic areas on a device, wherein each of the graphic areas is associated with a client application.

2. The server of claim 1, wherein the processor is further operable to detect an action associated with the account that changes the status of the account.

3. The server of claim 1, wherein the metric associated with the account is an account balance.

4. The server of claim 1, wherein the processor is further operable to communicate a push notification comprising the status to a device associated with the account,

5. The server of claim 1, wherein the device is one of a group consisting of a mobile phone, a tablet, a television, and an automobile.

6. The server of claim 1, wherein the processor is further operable to determine that the status of the account has changed from a previous status, wherein the device is configured to change an image in the first graphic area of the device in response to receiving the communication with the status of the account.

7. The server of claim 1, wherein the processor is further operable to facilitate displaying the status of the account in the first graphic area without a user of the device opening a client application associated with the first graphic area.

8. A method for determining a status of an account, comprising:
retrieving a metric associated with an account;
accessing rules for determining a status of the account;
determining, using a processor, the status of the account based on the metric associated with the account and the rules for determining the status of the account; and
communicating the status of the account to a device for display in a first graphic area of a plurality of graphic areas on a device, wherein each of the graphic areas is associated with a client application.

9. The method of claim 8, further comprising detecting an action associated with the account that changes the status of the account.

10. The method of claim 8, wherein the metric associated with the account is an account balance.

11. The method of claim 8, further comprising communicating a push notification comprising the status to a device associated with the account.

12. The method of claim 8, wherein the device is one of a group consisting of a mobile phone, a tablet, a television, and an automobile.

13. The method of claim 8, further comprising determining that the status of the account has changed from a previous status, wherein an image in the first graphic area of the device changes in response to receiving the communication with the status of the account.

14. The method of claim 8, further comprising facilitating display of the status of the account in the first graphic area without a user of the device opening a client application associated with the first graphic area.

15. A non-transitory computer readable medium comprising logic, the logic when executed by a processor, operable to:
retrieve a metric associated with the account;
access the rules for determining the status of the account;
determine the status of the account based on the metric associated with the account and the rules for determining the status of the account; and
communicate the status of the account to a device for display in a first graphic area of a plurality of graphic areas on a device, wherein each of the graphic areas is associated with a client application.

16. The computer readable medium of claim 15, wherein the logic is further operable to detect an action associated with the account that changes the status of the account.

17. The computer readable medium of claim 15, wherein the metric associated with the account is an account balance,

18. The computer readable medium of claim 15, wherein the logic is further operable to communicate a push notification comprising the status to a device associated with the account.

19. The computer readable medium of claim 15, wherein the logic is further operable to determine that the status of the account has changed from a previous status, wherein the device is configured to change an image in the first graphic area of the device in response to receiving the communication with the status of the account.

20. The computer readable medium of claim 15, wherein the logic is operable to facilitate displaying the status of the account in the first graphic area without a user of the device opening a client application associated with the first graphic area.

21. A device for determining a status of an account, comprising:
a memory comprising a plurality of client applications; and
a processor communicatively coupled to the memory and operable to:
display a plurality of graphic areas, wherein each of the graphic areas is associated with a client application;
display, in a first graphic area of the plurality of graphic areas, a first image that indicates a first status associated with the account;
receive a communication associated with an account; and
in response to receiving the communication, replace the first image in the first graphic area with a second image indicative of a second status associated with the account.

22. The device of claim 21, wherein the processor is further operable to replace the first image in the first graphic area with the second image without a user of the device opening a client application associated with the first graphic area.

23. The device of claim 21, further comprising a network interface operable to receive a push notification associated with the account.

24. The device of claim 21, wherein the processor is further operable to run a client application associated with the first graphic area and to change a theme of the client application in response to receiving the communication.
